(19) United States
(12) Patent Application Publication
(10) Pub. No.: US 2006/0007310 A1
(43) Pub. Date: Jan. 12, 2006

(54) Surveillance system and surveillance method

(75) Inventor: Chi-Hsien Shih, Chung Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies, Inc.

(21) Appl. No.: 11/159,710

(22) Filed: Jun. 23, 2005

(30) Foreign Application Priority Data
Jul. 9, 2004 (TW) 93120664

(51) Int. Cl. H04N 7/18; H04N 9/47

(52) U.S. Cl. 348/143

(57) ABSTRACT

A surveillance system and a surveillance method are described. The surveillance system has a video recorder and a video processing module. The video recorder records a scene and generates an original video signal. The scene has an area in need of coverage. The video processing module receives the original video signal. The video processing module performs an interference process on part of the image displaying the area in need of coverage and generates a post-processing video signal for displaying on a display. The interference process prevents the part of the image displaying the area in need of coverage from being identified.

### RELATED APPLICATIONS

The present application is based on, and claims priority from, Taiwan Application Serial Number 93120664, filed Jul. 9, 2004, the disclosure of which is hereby incorporated by reference herein in its entirety.

### FIELD OF THE INVENTION

The present invention relates to a surveillance system and a surveillance method, and more particularly, to a surveillance system and a surveillance method for the protection of privacy.

### BACKGROUND OF THE INVENTION

With increasing numbers of social activities, people have a greater need for security in both the work and home environment. The setting of a surveillance system is particularly common for city dwellers in an effort to prevent unexpected crimes or accidents. The surveillance system can automatically record environmental states, and can be a tool for collecting evidence when crimes are committed. It can also effectively prevent common crimes.

However, the omnipresent monitors sometimes invade personal privacy. When the surveillance system works, it sometimes records unnecessary scenes. For example, an ordinary street monitor records the scenes inside windows when monitoring buildings. The activities inside windows are personal, and this sort of content is not necessary for a surveillance system. Besides, recordation through windows of personal activities violates personal privacy. In some countries, shooting personal activities through windows is illegal. A conventional surveillance system is an unfriendly system because it does not deal with the inappropriate scenes recorded thereby.

### SUMMARY OF THE INVENTION

Therefore, one objective of the present invention is to provide a surveillance system and a surveillance method, which can monitor the environment and safeguard privacy.

Another objective of the present invention is to provide a surveillance system and a surveillance method, which can automatically interfere with an unnecessary part of the image and display a necessary part of the image.

According to the aforementioned objectives, the present invention provides a surveillance system. According to a preferred embodiment of the present invention, the surveillance system includes a video recorder and a video processing module. The video recorder records a scene and generates an original video signal. The scene includes an area in need of coverage, such as a window of a house. The video processing module receives the original video signal. The video processing module performs an interference process on part of the image displaying the area in need of coverage and generates a post-processing video signal for displaying on a display. The interference process prevents the part of the image displaying the area in need of coverage from being identified.

According to the aforementioned objectives, the present invention provides a surveillance method. According to a preferred embodiment of the present invention, the surveillance method includes the following steps. Firstly, a scene is recorded to generate an original video signal, in which the scene includes an area in need of coverage, such as a window of a house. Next, an interference process is performed on part of the image displaying the area in need of coverage in original video signal to generate a post-processing video signal. The part of the image displaying the area in need of coverage in post-processing video signal cannot be identified. Then, the post-processing video signal is stored in a storage medium.

The present invention comprises the following advantages. Because an interference process is performed on a part of the image displaying the area in need of coverage in the original video signal to interfere with the unnecessary part of the image and keep the necessary part of the image by the video processing module, the environment can be monitored, and the privacy can be protected. Furthermore, the present invention can eliminate unnecessary damage before the image is displayed on a display or a storage medium.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a diagram showing a first preferred embodiment of the present invention;

FIG. 2A illustrates a diagram showing an example of an original video signal;

FIG. 2B illustrates a diagram showing an example of a post-processing video signal; and

FIG. 3 illustrates a flow chart showing a surveillance method in accordance with a preferred embodiment of the present invention.

### DETAILED DESCRIPTION OF THE PREFERRED EMBODIMENT

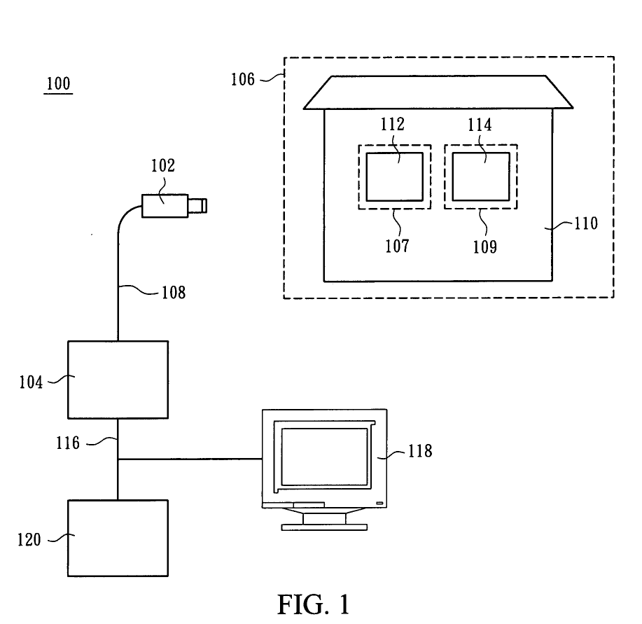

FIG. 1 illustrates a diagram showing a first preferred embodiment of the present invention. Referring to FIG. 1, a surveillance system 100 includes a video recorder 102 and a video processing module 104. The video recorder 102 is used to record a scene 106 to generate an original video signal 108. The scene 106 includes areas 107 and 109 in need of coverage. The areas 107 and 109 in need of coverage may be, for example, windows 112 and 114 of a house 110, as shown in FIG. 1. Users can select areas in need of coverage, and the present invention is not limited to the application regarding windows.

The video processing module 104 receives the original video signal 108. The video processing module 104 performs an interference process on a part of the image displaying the areas 107 and 109 in need of coverage in the original video signal 108 to generate a post-processing video signal 116 for displaying on a display 118. The interference process prevents the part of the image displaying the areas 107 and 109 in need of coverage from being identified.

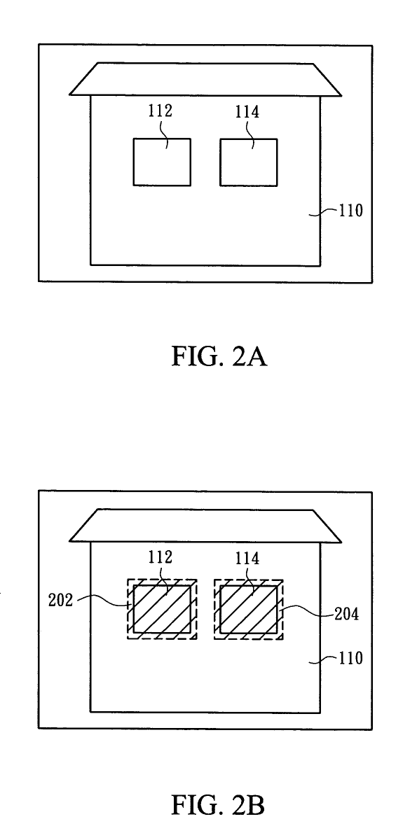

FIG. 2A illustrates a diagram showing an example of an original video signal. Referring to FIGS. 1 and 2A, the original video signal 108 is displayed as the scene 106 shown in FIG. 2A. The scene 106 shot by the surveillance system 100 near by the house 110 may include the surrounding environment and the house 110.

The surveillance system 100 is installed to monitor the house 110 and thereby prevent the house 110 from being illegally entered. However, when the video recorder 102 shoots the house 110, it shoots the scenes inside the windows 112 and 114. The activities inside the windows 112 and 114 are personal, and this sort of content is not necessary for the surveillance system 100. Besides, taking personal activities inside windows violates personal privacy. In some countries, shooting personal activities inside windows is illegal.

In view of this reason, the video processing module 104 performs an interference process on part of the image displaying the windows 112 and 114 in the original video signal 108 to generate a post-processing video signal 116 for displaying on the display 118. FIG. 2B illustrates a diagram showing an example of a post-processing video signal. Referring to FIG. 2B, parts 202 and 204 of the image represent the window 112 and 114 shown in FIG. 2A, respectively. The video processing module 104 performs an interference process on the parts 202 and 204 of the image. For example, the interference process can be performed by mosaicing the parts 202 and 204 of the image with software, or by removing the parts 202 and 204 of the image with software. In another example, the video processing module 104 performs a covering process on the parts 202 and 204 of the image.

Referring to FIG. 1, the video recorder 102 records the scene 106 by a static record method or a kinetic record method. In the kinetic record method, the video recorder 102 turns regularly. When the video recorder 102 performs a kinetic recording, the locations of the parts 202 and 204 of the image are changed with time, so that the video processing module 104 can calculate the locations of the parts 202 and 204 of the image changed with time in advance, and then perform an interference process on the parts 202 and 204 of the image.

The surveillance system 100 may include a storage medium 120 for storing the post-processing video signal 116. The storage medium 120 may be a magnetic tape or a hard disc. The video processing module 104 may be a computer, for example.

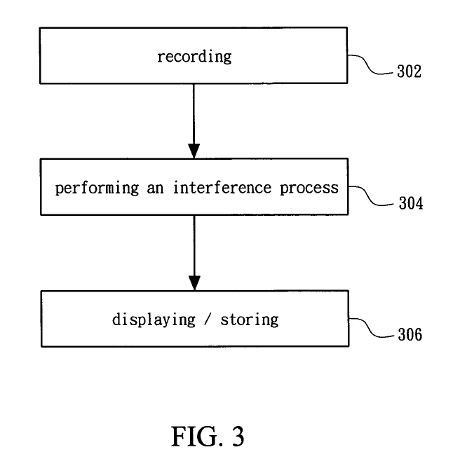

The aforementioned surveillance system is executed according to a method. FIG. 3 illustrates a flow chart showing a surveillance method in accordance with a preferred embodiment of the present invention. Referring to FIG. 3, the surveillance method includes the following steps. Firstly, a scene is recorded to generate an original video signal (step 302), in which the scene includes an area in need of coverage. Next, an interference process is performed on a part of the image displaying the area in need of coverage in original video signal to generate a post-processing video signal (step 304). The part of the image displaying the area in need of coverage in post-processing video signal cannot be identified. Then, the post-processing video signal is displayed on a display and/or stored in a storage medium (step 306). The details of the method are the same as described in the embodiment of the surveillance system 100, and are not described in detail herein.

According to the aforementioned description, the present invention comprises the following advantages. Because an interference process is performed on a part of the image displaying the area in need of coverage in the original video signal to interfere with the unnecessary part of the image and record the necessary part of the image by the video processing module, the environment can be monitored, and privacy can be protected. Furthermore, the present invention can eliminate unnecessary damage before the image is displayed on a display and/or stored in a storage medium.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A surveillance system, comprising:
a video recorder used to record a scene and generate an original video signal, wherein the scene includes an area in need of coverage; and
a video processing module, which receives the original video signal and performs an interference process on a part of the image displaying the area in need of coverage in the original video signal to generate a post-processing video signal for displaying on a display, wherein the interference process prevents the part of the image displaying the area in need of coverage in the post-processing video signal from being identified.

2. The surveillance system according to claim 1, wherein the area in need of coverage is a window of a house.

3. The surveillance system according to claim 1, further including a storage medium for storage of the post-processing video signal.

4. The surveillance system according to claim 3, wherein the storage medium is a magnetic tape or a hard disc.

5. The surveillance system according to claim 1, wherein the interference process is performed by mosaicing the part of the image displaying the area in need of coverage in the original video signal with software.

6. The surveillance system according to claim 1, wherein the interference process is performed by removing the part of the image displaying the area in need of coverage in the original video signal with software.

7. The surveillance system according to claim 1, wherein the interference process is performed by covering the part of the image displaying the area in need of coverage in the original video signal with software.

8. The surveillance system according to claim 1, wherein the video processing module includes a computer.

9. A surveillance system, comprising:
a video recorder used to record a scene and generate an original video signal, wherein the scene includes an area in need of coverage; and
a video processing module, wherein the video processing module receives the original video signal and performs an interference process on a part of the image displaying the area in need of coverage in the original video signal to generate a post-processing video signal for storage in a storage medium, wherein the interference process prevents the part of the image displaying the area in need of coverage in the post-processing video signal from being identified.

10. The surveillance system according to claim 9, wherein the storage medium is a magnetic tape or a hard disc.

11. The surveillance system according to claim 9, further including a display for displaying the post-processing video signal.

12. The surveillance system according to claim 9, wherein the interference process is performed by mosaicing the part of the image displaying the area in need of coverage in the original video signal with software.

13. The surveillance system according to claim 9, wherein the interference process is performed by removing the part of the image displaying the area in need of coverage in the original video signal with software.

14. The surveillance system according to claim 9, wherein the interference process is performed by covering the part of the image displaying the area in need of coverage in the original video signal with software.

15. The surveillance system according to claim 9, wherein the video processing module includes a computer.

16. A surveillance method, comprising:
recording a scene to generate an original video signal, wherein the scene includes an area in need of coverage;
performing an interference process on a part of the image displaying the area in need of coverage in the original video signal to generate a post-processing video signal, wherein the part of the image displaying the area in need of coverage in the post-processing video signal cannot be identified; and
storing the post-processing video signal in a storage medium.

17. The surveillance method according to claim 16, further including displaying the post-processing video signal by using a display.

18. The surveillance method according to claim 16, wherein the interference process includes mosaicing the part of the image displaying the area in need of coverage in the original video signal.

19. The surveillance method according to claim 16, wherein the interference process includes removing the part of the image displaying the area in need of coverage in the original video signal.

20. The surveillance method according to claim 16, wherein the interference process includes covering the part of the image displaying the area in need of coverage in the original video signal.
